(19) United States
(12) Patent Application Publication
(10) Pub. No.: US 2008/0255965 A1
(43) Pub. Date: Oct. 16, 2008

(54) METHOD OF SOLICITING BIDS FOR VEHICLE PURCHASE

(76) Inventor: Trevor Robert Milton, St. George, UT (US)

Correspondence Address: TERRENCE J. EDWARDS;CLAYTON, HOWARTH & CANNON, P.C., P.O. BOX 1909, SANDY, UT, 84091, US

(21) Appl. No.: 12/099,090

(22) Filed: Apr. 7, 2008

Related U.S. Application Data
(60) Provisional application No. 60/922,240, filed on Apr. 5, 2007.

(51) Int. Cl. G06Q 30/00

(52) U.S. Cl. 705/27

(57) ABSTRACT

A method of marketing items, such as vehicles, is disclosed. The method may include providing a database of contact information of potential purchasers including vehicle dealers. The database may be accessible via a global computer network. The method may include receiving input describing desired sales locations from vendors desiring to sell vehicles. The vendors may also supply data describing the vehicles to be sold. The data regarding the vehicles to be sold may be submitted to the dealers in the sales location selected by the vendor. The dealers may be allowed to assess the data and provide purchase offers. The purchase offers may be submitted to the vendors such that the vendors can quickly sell vehicles at a fair price.

### CROSS-REFERENCE TO RELATED APPLICATIONS

This application claims the benefit of U.S. Provisional Application No. 60/922,240 filed Apr. 5, 2007, which is hereby incorporated by reference herein in its entirety, including but not limited to those portions that specifically appear hereinafter, the incorporation by reference being made with the following exception: In the event that any portion of the above-referenced provisional application is inconsistent with this application, this application supercedes said above-referenced provisional application.

### STATEMENT REGARDING FEDERALLY SPONSORED RESEARCH OR DEVELOPMENT

Not Applicable.

### BACKGROUND

1. The Field of the Invention

The disclosure relates generally to methods for marketing items, and more particularly, but not necessarily entirely, to methods for soliciting purchase offers for marketing vehicles.

2. Description of Related Art

It is common practice for individuals and businesses to buy and sell goods over the Internet. Individuals wishing to sell items such as vehicles may place advertisements on the Internet for the general public to view. Such method of sale may not reach the purchasers most likely to purchase the vehicle. Moreover, such methods may require a long period of time to sell the vehicle.

On-line auctioning of items is also a common practice. However, auctioning may also be difficult to reach the most suitable purchasers. Accordingly, it may be difficult to sell an item in a short time frame for a reasonable price.

Individuals wishing to sell a vehicle are often confronted with the burden of selling the vehicle to other individuals, or selling the vehicle at an unfair, low price to a dealer. Both of these options may not be suitable for many individuals.

The prior art is thus characterized by several disadvantages that are addressed by the disclosure. The disclosure minimizes, and in some aspects eliminates, the above-mentioned failures, and other problems, by utilizing the methods and structural features described herein.

The features and advantages of the disclosure will be set forth in the description which follows, and in part will be apparent from the description, or may be learned by the practice of the disclosure without undue experimentation. The features and advantages of the disclosure may be realized and obtained by means of the instruments and combinations particularly pointed out in the appended claims.

### BRIEF DESCRIPTION OF THE DRAWINGS

The features and advantages of the disclosure will become apparent from a consideration of the subsequent detailed description presented in connection with the accompanying drawings in which:

FIG. 1 is a flow chart of steps useful with the method of the disclosure;

FIG. 2 is a schematic diagram showing a system for marketing items in accordance with the principles of the disclosure;

FIG. 3 is an illustration of a system of the disclosure;

FIG. 4 is an illustration of another system of the disclosure;

FIG. 5 is an a illustration of another system of the disclosure; and

FIG. 6 is an illustration of a webpage for display to a user in accordance with the principles of the disclosure.

### DETAILED DESCRIPTION

For the purposes of promoting an understanding of the principles in accordance with the disclosure, reference will now be made to the embodiments illustrated in the drawings and specific language will be used to describe the same. It will nevertheless be understood that no limitation of the scope of the disclosure is thereby intended. Any alterations and further modifications of the inventive features illustrated herein, and any additional applications of the principles of the disclosure as illustrated herein, which would normally occur to one skilled in the relevant art and having possession of this disclosure, are to be considered within the scope of the disclosure claimed.

Before the present systems and methods of soliciting bids for vehicle purchase are disclosed and described, it is to be understood that this disclosure is not limited to the particular configurations, process steps, and materials disclosed herein as such configurations, process steps, and materials may vary somewhat. It is also to be understood that the terminology employed herein is used for the purpose of describing particular embodiments only and is not intended to be limiting since the scope of the disclosure will be limited only by the appended claims and equivalents thereof.

It must be noted that, as used in this specification and the appended claims, the singular forms “a,” “an,” and “the” include plural referents unless the context clearly dictates otherwise. Moreover, as used herein, the terms “comprising,” “including,” “containing,” “characterized by,” and grammatical equivalents thereof are inclusive or open-ended terms that do not exclude additional, unrecited elements or method steps.

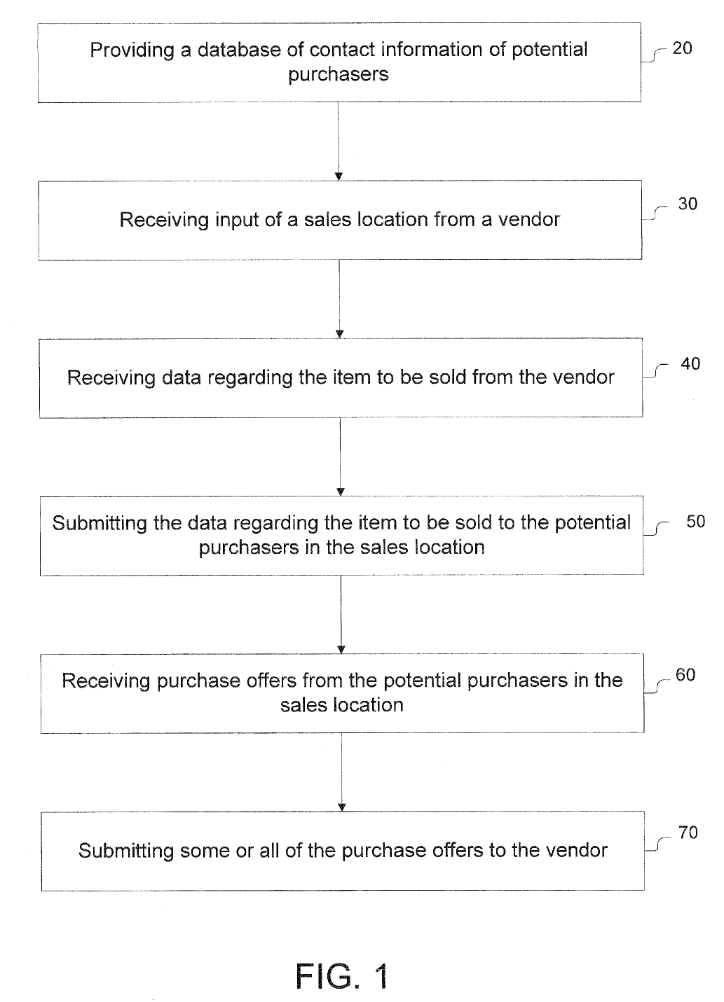

Referring now to FIG. 1, a flow chart is shown, including one embodiment of method steps useful in accordance with the principles of the disclosure. It will be understood that some embodiments of the disclosure may not include all of the steps depicted in FIG. 1, and that other embodiments may include additional steps beyond those depicted in FIG. 1. It will also be understood that the order of the steps may vary in accordance with the principles of the disclosure. Moreover, it will be understood that although the embodiment depicted in FIG. 1 may be discussed in the context of a method used for the sale of vehicles, the concepts of the disclosure are useful for the sale of various different goods or services.

The embodiment of FIG. 1 may include the step, indicated at 20, of providing a database of contact information of potential purchasers. The database may include contact information of vehicle dealers or individuals associated with vehicle dealers that may be in charge of purchasing vehicles. It will be understood that the term “vehicle” as used herein shall be construed broadly to include any means of conveyance, such as automobiles, motorcycles, trucks, water craft, aircraft, trailers, off-road vehicles, and the like.

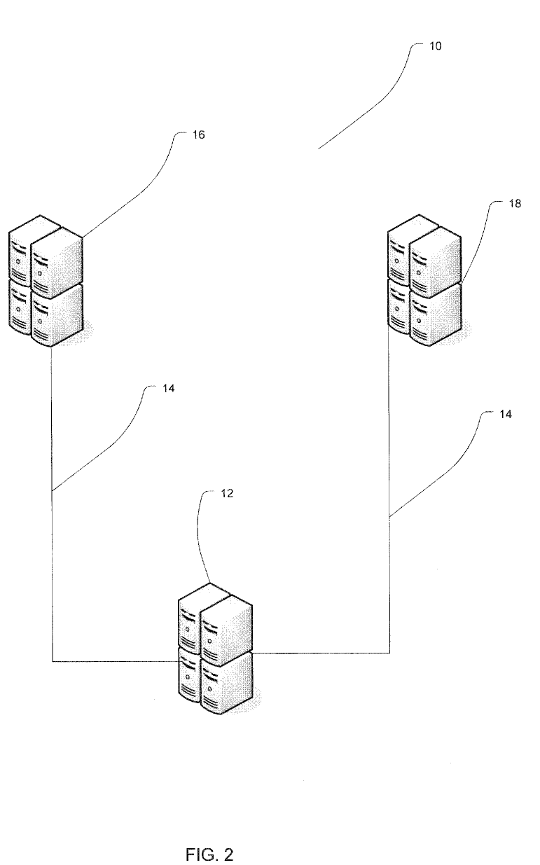

A schematic view of one embodiment of a system useful with the present methods is depicted in FIG. 2, indicated generally at 10. It will be understood that a database 12 may be provided on a computer, server, or storage device in any manner known to those skilled in the art. The database 12 may be connected to a network 14, such as a global computer network, the Internet, a wide-area network or a local area network, or any combination of such networks. Alternatively, one embodiment of the disclosure may include a database on a computer without a connection to a network. It will also be understood that wireless data transmissions may be used within the scope of the disclosure. It will be understood that access to the database 12 may be restricted or a fee may be charged for access to the database 12.

The database 12 may include the contact information of potential purchasers in correlation to a geographic location. Accordingly, the method may also involve the step of receiving input of a sales location from a vendor 16. For example, the vendor 16 may be an individual residing in a particular area having access to a data transmission device such as a computer depicted in FIG. 2. The vendor 16 may not be interested in selling an item at a location remote from his or her residence, since the cost and burden of arranging the transaction over a long distance may not be worthwhile. It will be understood that the term “vendor” as used herein shall be construed broadly to include any individual, group or entity wishing to sell an item, such as a vehicle.

The present method may involve receiving input of a sales location from a vendor 16, as indicated at 30 in FIG. 1. The vendor 16 may provide information via a computer connected to the database 12 through the network 14 in a manner known in the art. For example, it will be understood that the vendor 16 may utilize any data transmission device known in the art, such as a keyboard, keypad, mouse, audio recognition system, telephone, personal digital assistant (PDA), or the like, to transmit data to the database 12.

The vendor 16 may provide a sales location in the form of a zip code, address, city, or the like. The vendor 16 may also provide information such as a radius from the zip code, address, or city, for which the vendor 16 desires to sell the item. For example, the vendor 16 may select a radius of any desired distance, such as 25 miles, for example, from the particular zip code of the vendor 16. Potential purchasers 18 or dealers that are located within the specified 25 miles of the particular zip code may then be identified. It will be understood that any desired method of specifying a vendor 16 location and any desired radius from the vendor location may be utilized within the scope of the disclosure.

The present method may also include receiving data regarding the item to be sold from the vendor 16, as indicated by reference numeral 40. The data regarding the item to be sold may include information such as the make, model, year, color, mileage, optional equipment, condition, and the like of a vehicle. It will be understood that any other data useful for the sale of an item or vehicle may be provided by the vendor 16 in accordance with the principles of the disclosure.

The data regarding the item to be sold may then be submitted to the potential purchasers 18 in the sales location. It will be understood that the potential purchasers 18 may also have access to a data receiving and transmission device in a manner similar to the computer of the vendor 16 as depicted in FIG. 2. For example, if twenty dealers were located in the sales location selected by the vendor 16, the information such as the make, model, year, color, mileage, optional equipment, condition, and the like of a vehicle, may be provided to each of the twenty dealers. The dealers could then assess the information and determine whether or not they want to offer to purchase the vehicle from the vendor 16, their proposed purchase price and any other terms and conditions for the purchase.

The method may then include receiving purchase offers from the potential purchasers or dealers, as indicated by reference numeral 60. The purchase offers, also sometimes referred to as bids, may then be stored in the database 12 and analyzed to rank the purchase offers based on sales price. The method may then involve submitting some or all of the purchase offers to the vendors 16, as indicated by reference numeral 70. One embodiment of the disclosure may include submitting the five highest purchase offers to the vendor 16. It will be understood, however, that alternative embodiments of the disclosure may include submitting fewer or more than the five highest purchase offers to the vendor 16. Other information may also be submitted to the vendors 16, such as the contact information of the potential purchasers and the terms and conditions of the purchase.

Once the vendor 16 receives the purchase offers, the vendor 16 may assess the offers and determine which, if any of the offers the vendor 16 wishes to accept. The sale of the item can then be completed.

One embodiment of the disclosure may include requiring the potential purchasers 18 to submit the purchase offers within a predetermined time, such that the purchase offers may be submitted to the vendor 16 within a specified time frame. For example, one embodiment of the disclosure may provide for the vendors 16 to receive the purchase offers within 72 hours. It will be appreciated that various different time periods for providing the purchase offers may be used within the scope of the disclosure.

It will be understood that the system 10 illustrated in FIG. 2 is for exemplary purposes only. Any number of vendors 16 and potential purchasers 18 may be used with the system 10. Moreover, it will be under stood that the data storage and transmission devices depicted in FIG. 2 for use by the vendors 16 and potential purchasers 18 with the database 12 may be any variety of data storage and transmission devices known to those skilled in the art.

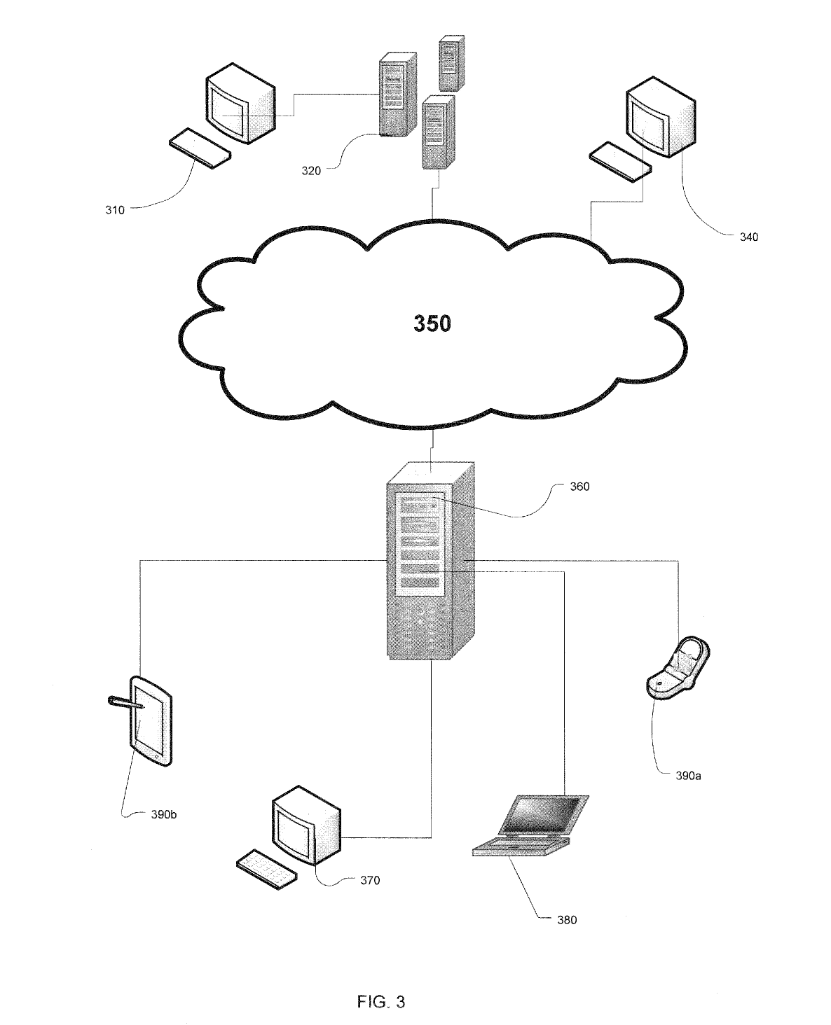

FIG. 3 illustrates an embodiment of soliciting bids over a network. The embodiment of FIG. 3 may include a terminal 310 for receiving input from a vender relating to a vehicle, wherein the vender may input an asking price and other vehicle information relating to the specific vehicle, which is then processed by a server or server cluster 320, such inputs may comprise, vehicle type, vehicle make, vehicle model, and other vehicle specifications. The vehicle type may refer to the category of vehicle, and may be for example automobiles, such as cars, trucks, vans, sport-utility vehicles, classic cars, hot rods and others, snowmobiles, motorcycles, off road vehicles including all terrain vehicles, personal watercraft, boats, recreation vehicles, trailers, truck campers, motor homes, camping trailers and aircraft.

A computer 340 may also be used for accessing a sever 320 and may make said access over the internet 350 for bidding purposes. Server 320 may also be connected to the internet and may be set to use proprietary and non-proprietary protocols for providing and receiving data from the internet 350. At a computer 340 the vendor may input an asking price and other vehicle information relating to the specific vehicle which is then processed by a server or server cluster 320, such inputs may comprise, vehicle type, vehicle make, vehicle model, and other vehicle specifications. The vehicle type may refer to the category of vehicle, and may be for example automobiles, such as cars, trucks, vans, sport-utility vehicles, classic cars, hot rods and others, snowmobiles, motorcycles, off road vehicles including all terrain vehicles, personal watercraft, boats, recreation vehicles, trailers, truck campers, motor homes, camping trailers and aircraft.

The vehicle make may refer to the company who manufactured the particular vehicle. The vehicle model may refer to the name of the particular line of vehicles that a manufacturer produces. The vehicle trim and specifications include the options and features of that may be added to a given model, such as the size of the engine, the drive-train, safety features, comfort and convenience features, music and entertainment features and packages, interior and exterior features, tire size and wheel type.

A server 360 may be accessed through the internet 350. Servers 360 may process databases of potential bids or buyers generally for the purpose of purchasing over the internet 350. Server 360 may be used for the distribution of bidding information processed and developed on server 320 and computer 340. Server 360 may directly or through the internet convey data to computer 370, mobile computer 360, and dedicated mobile devices 390a and 390b for users to bid or access bidding information.

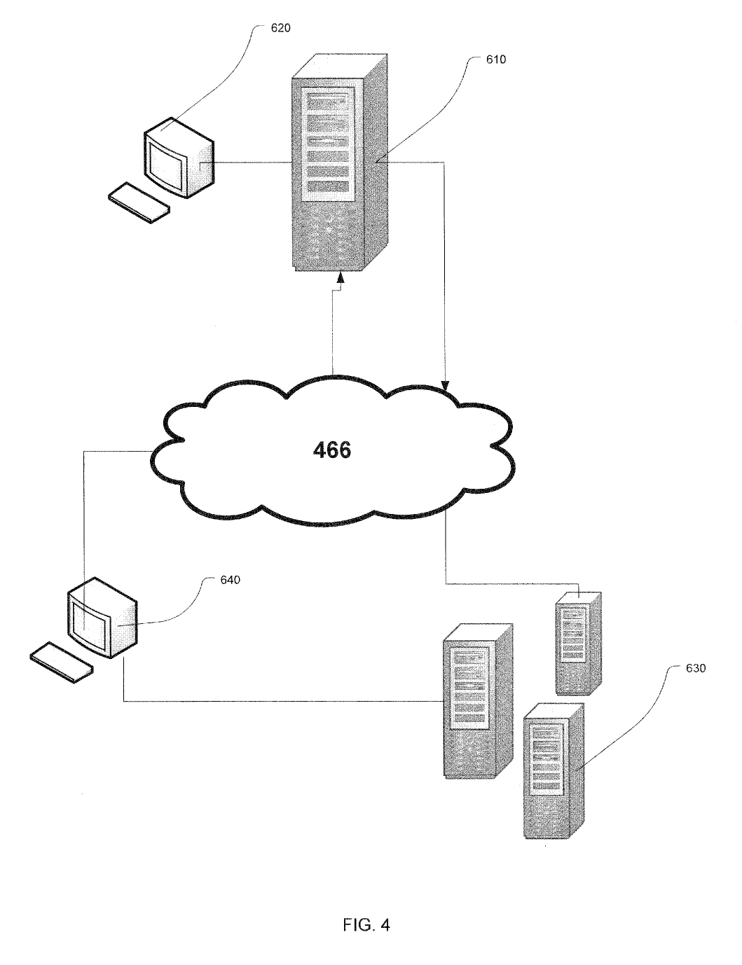

An embodiment illustrated in FIG. 4 may include a sever 401 accessed by a terminal 402 for providing access to a vehicle information database comprising bid information, retail values, trade-in values and other vehicle data stored in memory and storage thereon. Another server or server cluster 403 having a vehicle information database of average high retail values, average low retail values, average high trade-in values, and average low-trade-in values, wherein the values are based on national sales data or bid information. A terminal 404 may be connected to server 403 through the internet 466. Such information may be entered at a terminal 404 or a plurality of terminals. Terminal 404 may display the bid or vehicle information database in the form of webpage or a website for use by potential purchasers and sellers.

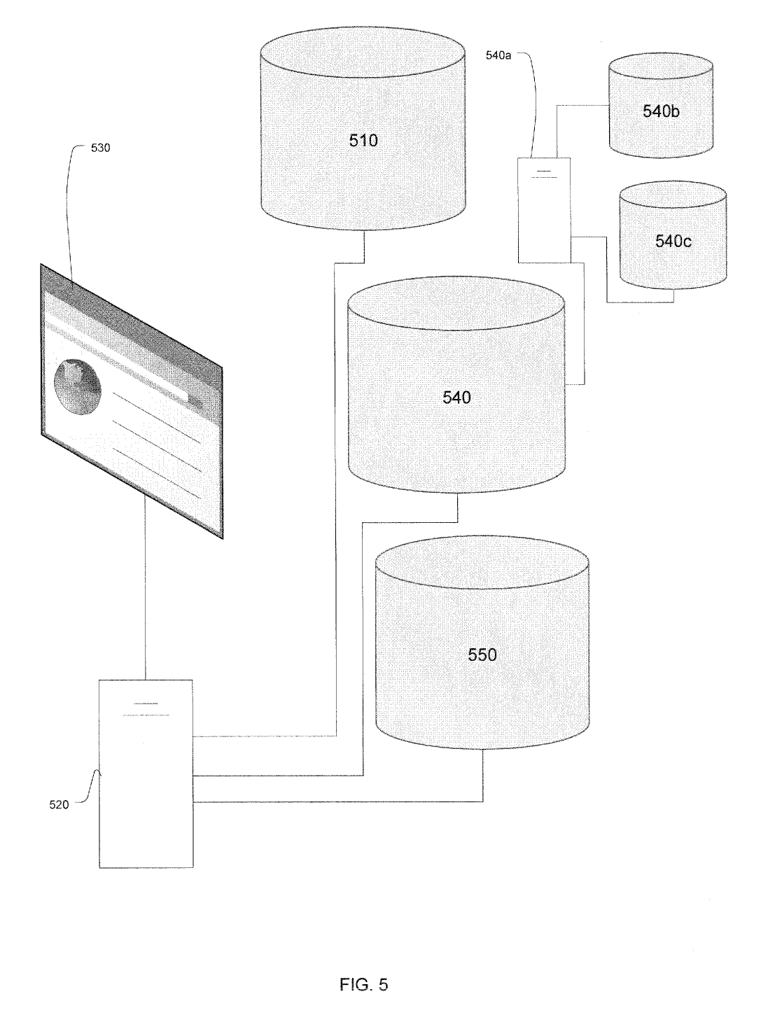

The embodiment of FIG. 5 illustrates a data management structure for managing the data. A data base 510 may store and organize information related to bid sources accessed for providing bid information. Such bid information may include non-proprietary and proprietary sources that may be desirable to a user. In operation, a processor 520 will execute instructions provided by the operator or by a computer program. Data from database 510 is accessed by the processor 520 and may direct the processor to access additional data of database 540 and database 550. Database 540 may store multiple data types that may be stored on integrated or sub-data bases 540b and 540c. Sub-databases may be accessed by a sub-processor 540a. Data base 540 may contain information such as item attributes and item value information. Data base 550 may include standard item values. Processor 520 may direct data to be displayed and formatted in a web page 530. In use, a user may select an instruction from web page 530 and the instruction is executed by the processor 520. Processor 520 accesses database 510 and select a source for item information. The processor 520 may then access data base 540 to retrieve item attribute information and item value information for an actual item on the market. In this embodiment a sub-processor 540a may access sub-database 540b storing attribute information. Sub processor 540a may access sub-database 540c storing value information. Sub-processor 540a may correlate the value and attribute data in a predetermined form that constitutes the database 540. Processor 520 may access database 550, which may contain standardized or known item values over time. The processor 520 may then compare the data accessed from databases 510, 540, and 550.

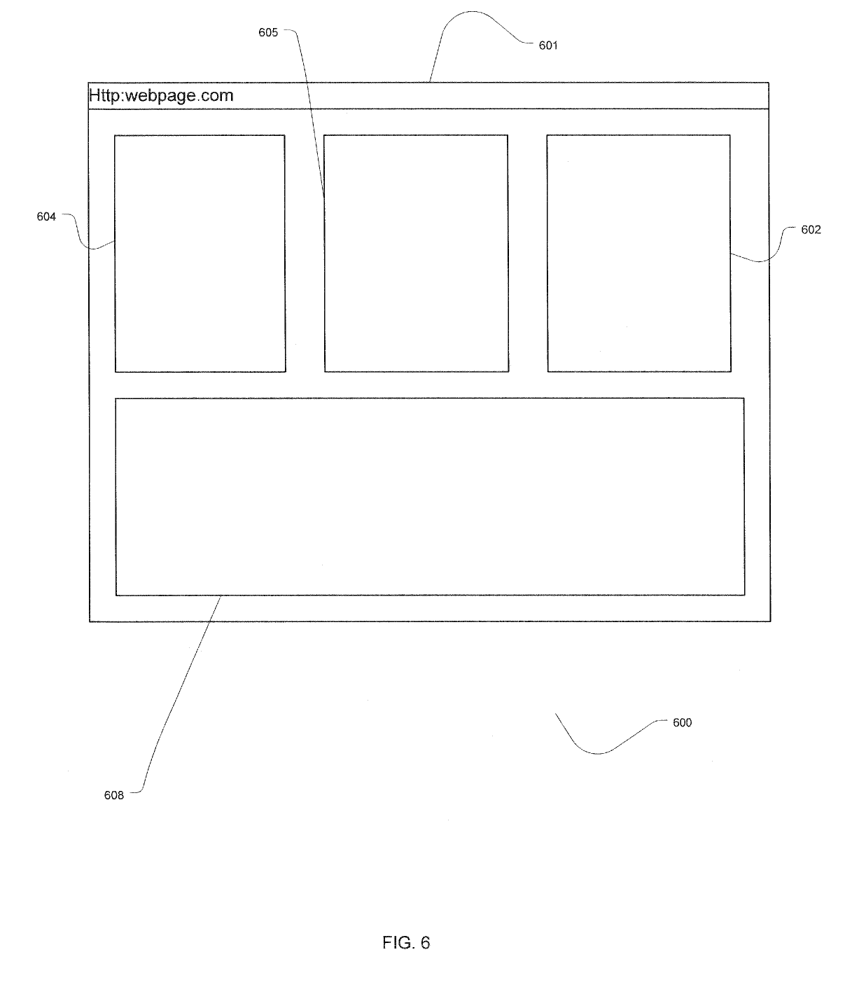

FIG. 6 illustrates an embodiment of a web page for providing a vehicle listing for marketing the vehicle to potential purchasers, wherein the vehicle listing comprises bid information of said vehicle. Such data to be displayed on the web page 600 may comprise the vehicle listing values or values of an item, the trade-in values and the bid information, thereby providing potential purchasers and consumers with immediate feedback regarding the overall value of that specific vehicle. Referring now to FIG. 6 an embodiment of a web page 600 will be discussed further. An address portion 601 may be provided wherein an internet address my be inserted and may direct the nature of databases accessed by the system wherein it resides. A portion 602 may be provided wherein item attributes input by the user may be displayed. A portion 604 may be provided wherein standardized data may be provided to a user. A portion 605 may be provided wherein the bid information may be accessed and provided. A portion 608 may be provided where history or summary data may be displayed. It should be understood that additional portions may be provided to convey information to a user, such as advertizing and related or unrelated information. It should also be understood that different configurations are within the scope of this disclosure, for varying devices whether connected or wireless.

It will be appreciated that the structure and apparatus disclosed herein is merely one example of a means for performing the specified function, and it should be appreciated that any structure, apparatus or system for the function which performs functions the same as, or equivalent to, those disclosed herein are intended to fall within the scope of a means for performing the specified function, including those structures, apparatus or systems for the function which are presently known, or which may become available in the future. Anything which functions the same as, or equivalently to, a means for performing the specified function falls within the scope of these elements.

In accordance with the features and combinations described above, a useful method of marketing items, may include the steps of:

providing a database of contact information of potential purchasers;

receiving input of a sales location from a vendor;

receiving data regarding the item to be sold from the vendor;

submitting the data regarding the item to be sold to the potential purchasers in the sales location;

receiving purchase offers from the potential purchasers in the sales location; and submitting some or all of the purchase offers to the vendor.

Those having ordinary skill in the relevant art will appreciate the advantages provide by the features of the disclosure. For example, it is a feature of the disclosure to provide a method of soliciting bids for vehicle purchase that is simple to use. Another feature of the disclosure is to provide such a method of soliciting bids that can be used to sell an item quickly. It is a further feature of the disclosure, in accordance with one aspect thereof, to provide a method of soliciting bids for items that allows the vendor to obtain a fair price for the items. It is another feature of the disclosure to provide a method that allows a vendor to target potential purchasers within a specified area. It is a further feature of the disclosure to provide a method that allows individual vendors to market vehicles to vehicle dealers.

In the foregoing Detailed Description, various features of the disclosure are grouped together in a single embodiment for the purpose of streamlining the disclosure. This method of disclosure is not to be interpreted as reflecting an intention that the claimed disclosure requires more features than are expressly recited in each claim. Rather, as the following claims reflect, inventive aspects lie in less than all features of a single foregoing disclosed embodiment. Thus, the following claims are hereby incorporated into this Detailed Description of the Disclosure by this reference, with each claim standing on its own as a separate embodiment of the disclosure.

It is to be understood that the above-described arrangements are only illustrative of the application of the principles of the disclosure. Numerous modifications and alternative arrangements may be devised by those skilled in the art without departing from the spirit and scope of the disclosure and the appended claims are intended to cover such modifications and arrangements. Thus, while the disclosure has been shown in the drawings and described above with particularity and detail, it will be apparent to those of ordinary skill in the art that numerous modifications, including, but not limited to, variations in size, materials, shape, form, function and manner of operation, assembly and use may be made without departing from the principles and concepts set forth herein.

What is claimed is:

1. A method of marketing items, said method comprising:
providing a database of contact information of potential purchasers;
receiving input of a sales location from a vendor;
receiving data regarding the item to be sold from the vendor;
submitting the data regarding the item to be sold to the potential purchasers in the sales location;
receiving purchase offers from the potential purchasers in the sales location; and
submitting some or all of the purchase offers to the vendor.

2. The method of claim 1, wherein the method is accomplished over a network.

3. The method of claim 1, wherein the potential purchasers are vehicle dealers.

4. The method of claim 1, wherein the input of sales location is an area defined by radius from a zip code.

5. The method of claim 1, wherein the input of sales location is an area defined by radius from an address.

6. The method of claim 1, wherein the item to be sold from the vendor is a vehicle.

7. The method of claim 6, wherein the data regarding the item to be sold comprises information pertaining to the type and condition of the vehicle.

8. The method of claim 1, wherein receiving purchase offers from the potential purchasers in the sales location comprises receiving terms and conditions of the purchase.

9. The method of claim 1, further comprising ranking the purchase offers based on price.

10. The method of claim 9, wherein submitting some or all of the purchase offers to the vendor comprises submitting the purchase offers having the highest prices.

11. The method of claim 10, wherein submitting the purchase offers having the highest prices comprises submitting five of the purchase offers having the highest prices.

12. The method of claim 1, further comprising providing contact information regarding the potential purchasers to the vendor.

13. A method of marketing a vehicle to dealers over a network, said method comprising:
providing a database of contact information of said dealers;
receiving data regarding the vehicle from a vendor;
submitting the data regarding the vehicle to one or more of the dealers;
receiving purchase offers from one or more of the dealers; and
submitting one or more of the purchase offers to the vendor.

14. The method of claim 13, further comprising receiving input of a sales location from the vendor.

15. The method of claim 14, wherein the input of sales location is an area defined by radius from a zip code.

16. The method of claim 15, wherein the zip code and radius are selected by the vendor.

17. The method of claim 13, wherein the data regarding the vehicle comprises information pertaining to the type and condition of the vehicle.

18. The method of claim 13, wherein receiving purchase offers from the dealers comprises receiving terms and conditions of the purchase.

19. The method of claim 13, further comprising ranking the purchase offers based on price.

20. The method of claim 19, wherein submitting one or more of the purchase offers to the vendor comprises submitting the purchase offers having the highest prices.

21. The method of claim 20, wherein submitting the purchase offers having the highest prices comprises submitting five purchase offers having the highest prices.

22. The method of claim 13, wherein the vendor is a non-dealer individual.

23. The method of claim 13, further comprising submitting the one or more of the purchase offers to the vendor within a specified time frame.

24. The method of claim 23, wherein the specified time frame is 72 hours.

25. A system for marketing items, said system comprising:
a first database of potential purchasers in a specified area;
a second database for receiving data from vendors regarding items to be sold;
a processor for selecting potential purchasers in the specified area based on data correlated from said first database and said second database;
storage for storing purchase offers from the potential purchasers; and
a network for submitting the purchase offers to the vendors.
